(19) United States
(12) Patent Application Publication
(10) Pub. No.: US 2014/0028716 A1
(43) Pub. Date: Jan. 30, 2014

(54) METHOD AND ELECTRONIC DEVICE FOR GENERATING AN INSTRUCTION IN AN AUGMENTED REALITY ENVIRONMENT

(71) Applicant: MITAC INTERNATIONAL CORP., Taoyuan County (TW)

(72) Inventor: Yao-Tsung YEH, Tapei City (TW)

(73) Assignee: MITAC INTERNATIONAL CORP., Taoyuan County (TW)

(21) Appl. No.: 13/952,830

(22) Filed: Jul. 29, 2013

(30) Foreign Application Priority Data
Jul. 30, 2012 (TW) 101127442

(51) Int. Cl. G06T 19/00

(52) U.S. Cl. CPC G06T 19/006
USPC 345/633

(57) ABSTRACT

A method for generating an instruction in an augmented reality environment includes capturing a series of reality images, each of which contains a portion of a hand, and a scene that includes at least one object-of-interest, recognizing the object-of-interest, generating an icon associated with an entry of object-of-interest data that is associated with the object-of-interest thus recognized, generating a series of augmented reality images by overlaying the icon onto the series of reality images, displaying the augmented reality images, recognizing a relationship between the portion of the hand and the icon, and generating an input instruction with reference to the relationship.

### CROSS-REFERENCE TO RELATED APPLICATION

This application claims priority of Taiwanese Patent Application No. 101127442, filed on Jul. 30, 2012.

### BACKGROUND OF THE INVENTION

1. Field of the Invention

The invention relates to a method and an electronic device for generating an instruction, more particularly to a method and an electronic device for generating an instruction in an augmented reality environment.

2. Description of the Related Art Augmented reality is a technology that supplements a live view of a real-world environment with computer-generated elements, such as graphics, sound, GPS data, etc. In this way, virtual objects are integrated into the real world so as to enhance a user's perception of reality.

A current application of augmented reality is to be utilized in combination with a navigation device and an image capturing device, for example, a real-time augmented reality device disclosed in U.S. Patent Application Publication No. 2011/0228078. In this art, the real-time augmented reality device stores an actual length and an actual width of an object, determines a virtual length and a virtual width of the object in a real-time image which is captured by the image capturing device, generates guidance information according to the actual length, the actual width, the virtual length, the virtual width and navigation information provided by the navigation device, and incorporates the guidance information into the real-time image so as to generate a navigation image. The navigation image may be displayed on a display device for reference by a driver in real time without a requirement for storage of high-cost 3D pictures and still photos in the real-time augmented reality device.

However, the aforementioned real-time augmented reality device is merely used to facilitate realization of the navigation image for easier recognition by the user. The user still needs to perform input operations through a touch screen or physical buttons of the real-time augmented reality device.

### SUMMARY OF THE INVENTION

Therefore, an object of the present invention is to provide a method and an electronic device for generating an instruction in an augmented reality environment by recognizing a relationship between a portion of a hand and an icon.

Accordingly, the method of this invention is to be performed using an electronic device which includes a display unit, an image capturing unit, a memory that stores a plurality of entries of object-of-interest data, and a controller coupled electrically to the display unit, the image capturing unit and the memory. The method comprises the steps of:
(A) capturing, by the image capturing unit, a series of reality images, each of which contains at least a portion of a hand and further contains a scene that includes at least one object-of-interest and that serves as a background of the portion of the hand;
(B) recognizing, by the controller, the object-of-interest in one of the reality images captured by the image capturing unit;
(C) generating, by the controller, at least one icon associated with the entry of object-of-interest data in the memory that is associated with the object-of-interest thus recognized;
(D) generating, by the controller, a series of augmented reality images by overlaying the at least one icon onto the series of reality images captured by the image capturing unit;
(E) displaying, by the display unit, the augmented reality images;
(F) recognizing, by the controller, a relationship between the portion of the hand and the at least one icon in the series of augmented reality images; and
(G) generating, by the controller, an input instruction with reference to the relationship recognized in step (F).

Another object of the present invention is to provide an electronic device which comprises a display unit, an image capturing unit, a memory and a controller. The image capturing unit is for capturing a series of reality images, each of which contains at least a portion of a hand and further contains a scene that includes at least one object-of-interest and that serves as a background of the portion of the hand. The memory stores a plurality of entries of object-of-interest data. The controller is coupled electrically to the display unit, the image capturing unit and the memory.

The controller is configured to: recognize the object-of-interest in one of the reality images captured by the image capturing unit; generate at least one icon associated with the entry of object-of-interest data in the memory that is associated with the object-of-interest thus recognized; and generate a series of augmented reality images by overlaying the at least one icon onto the series of reality images captured by the image capturing unit. The display unit is configured to display the augmented reality images. The controller is further configured to: recognize a relationship between the portion of the hand and the at least one icon in the series of augmented reality images; and generate an input instruction with reference to the relationship recognized thereby.

### BRIEF DESCRIPTION OF THE DRAWINGS

Other features and advantages of the present invention will become apparent in the following detailed description of two preferred embodiments with reference to the accompanying drawings, of which:

FIG. 1 illustrates a block diagram of an electronic device according to the present invention;

FIG. 2 is a flowchart illustrating a method for generating an instruction in an augmented reality environment according to the present invention;

Each of FIGS. 3 to 6 is an augmented reality image for illustrating a first preferred embodiment of the method according to the present invention;

Each of FIGS. 7 to 15 is an augmented reality image for illustrating a second preferred embodiment of the method according to the present invention; and

FIG. 16 is a flowchart illustrating another embodiment of the method according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

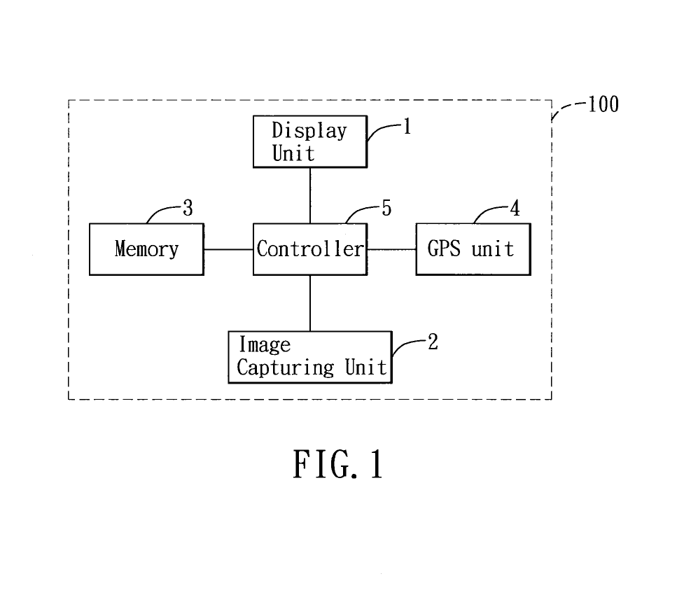

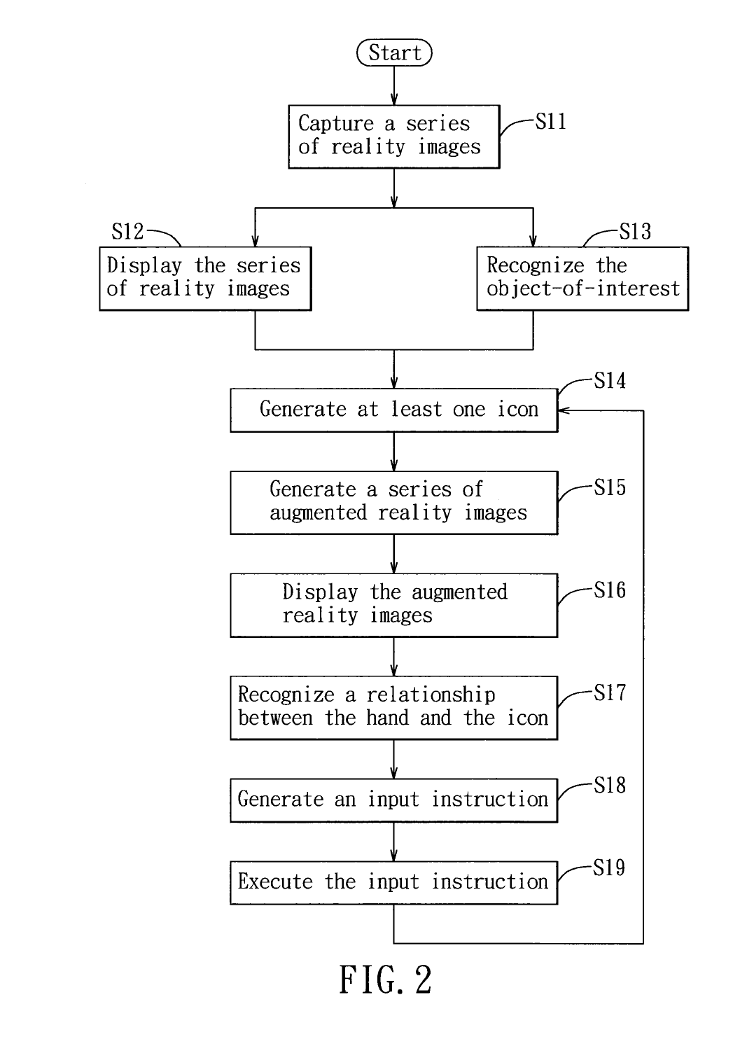

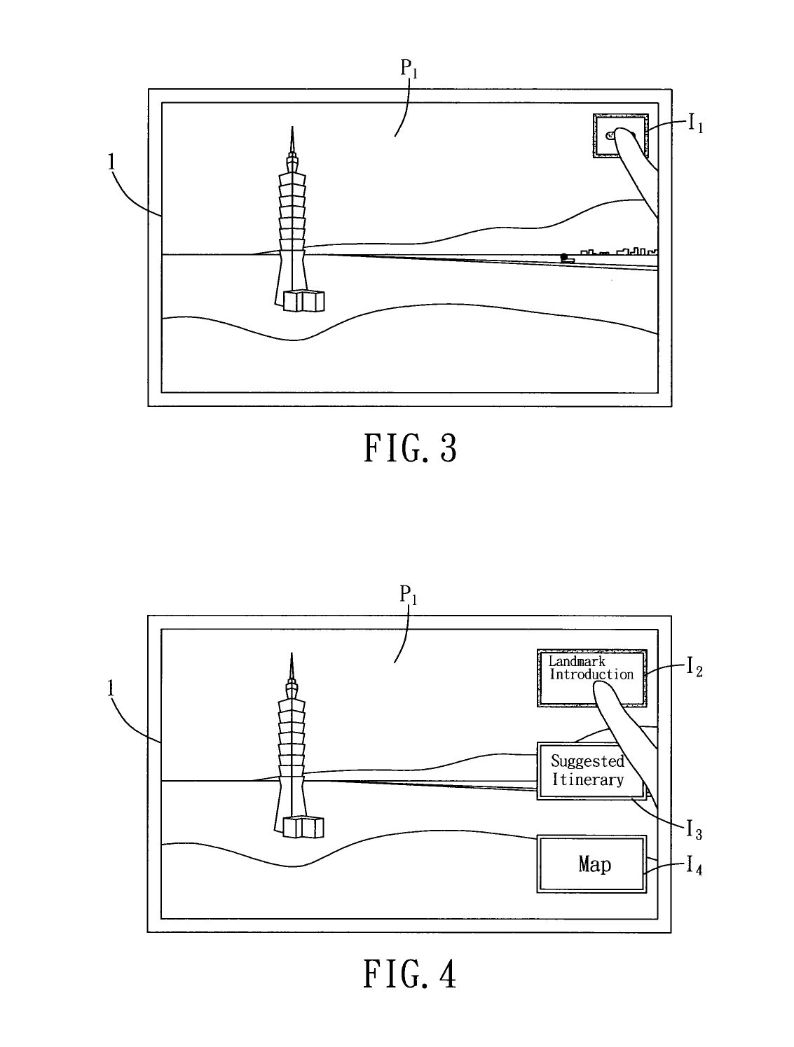

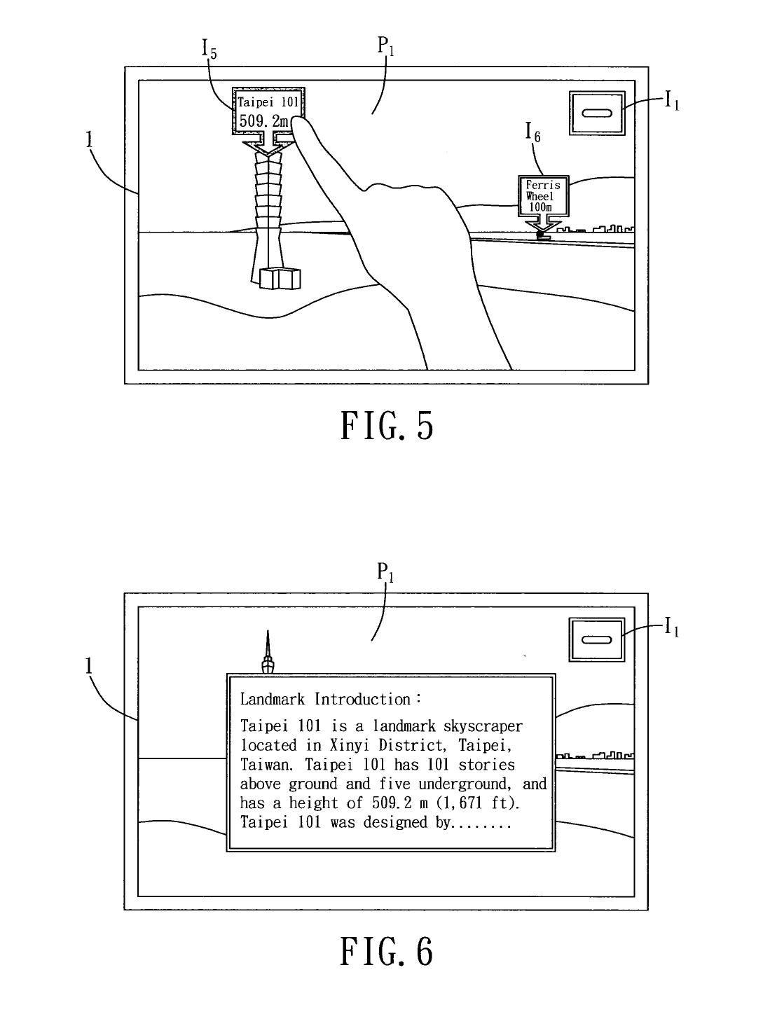

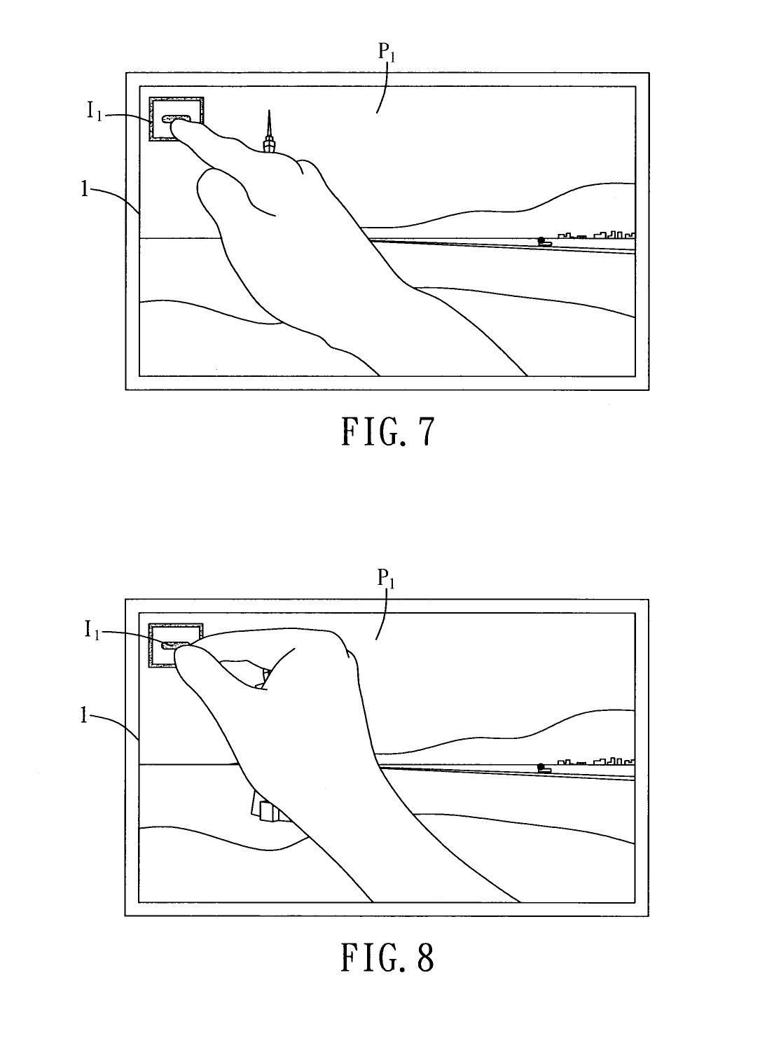

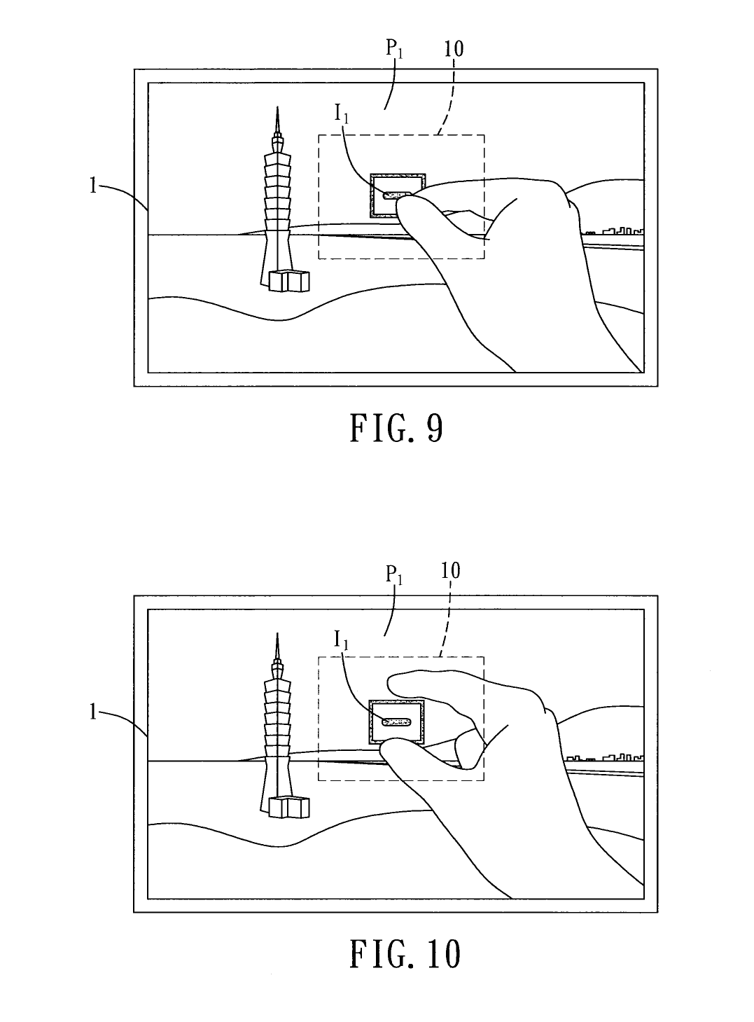

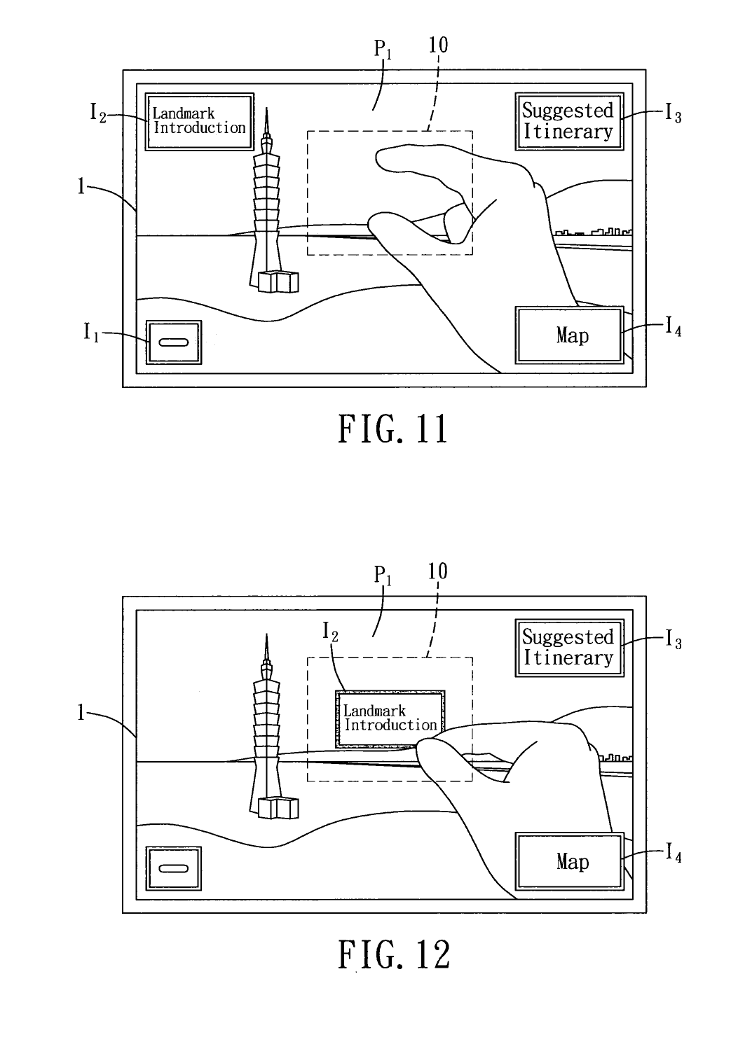

Referring to FIG. 1 and FIG. 2, a first preferred embodiment of a method for generating an instruction in an augmented reality environment according to the present invention is to be performed using a portable electronic device 100. The portable electronic device 100 includes a display unit 1 which faces a user when the portable electronic device 100 is in use for enabling the user to view images thereon, an image capturing unit 2 which faces toward a direction to which the user faces, a memory 3, a positioning unit which outputs a current position of the portable electronic device 100, and a controller 5 which is coupled electrically to the display unit 1, the image capturing unit 2, the memory 3 and the positioning unit. The memory 3 stores a plurality of entries of object-of-interest data, and program instructions associated with the method for generating the instruction in the augmented reality environment. In the first preferred embodiment, the positioning unit is a global positioning system (GPS) unit 4 which is configured to receive and output a GPS signal that contains the current position of the portable electronic device 100. In the first preferred embodiment, the object-of-interest is a landmark, and the entries of object-of-interest data include latitude and longitude coordinates of landmarks, landmark addresses, maps, suggested itineraries and landmark introductions.

In use, the image capturing unit 2 captures a series of reality images, and the display unit 1 displays the series of reality images. When the user extends a portion of the user's hand into a field of view of the image capturing unit 2 of the portable electronic device 100, the controller 5 is configured to recognize an object in the series of reality images which conforms to a predetermined condition, and then the portable electronic device 100 is enabled to initiate the method according to the present invention. The predetermined condition, for example, may be one of a palm shape pattern, a finger shape pattern, and an object which occupies a specific region on the series of reality images.

When the method according to the present invention is initiated, the controller 5 is configured to read the program instructions in the memory 3 and to perform the method which comprises the following steps.

In step S11, the image capturing unit 2 is configured to capture, in a fixed direction, a series of reality images as shown in FIG. 3. Each of the series of reality images contains at least a portion of a hand which may change over time, and further contains a scene that includes at least one object-of-interest (i.e., a landmark) and that serves as a background of the portion of the hand. The background substantially does not change over a short period of time.

In step S12, the display unit 1 is configured to continuously display the series of reality images in real-time.

In step S13, meanwhile, the controller 5 is further configured to recognize the object-of-interest, i.e., the landmark, in one of the reality images captured by the image capturing unit 2. Specifically, the controller 5 is configured to find from the entries of object-of-interest data in the memory 3 at least one candidate entry of object-of-interest data corresponding to a candidate object-of-interest located within an area that contains the current position of the portable electronic device 100 and that is associated with a field of view of the image capturing unit 2, and to find the candidate object-of-interest in said one of the reality images captured by the image capturing unit 2. The candidate object-of-interest found by the controller 5 in said one of the reality images is recognized by the controller 5 as the object-of-interest in said one of the reality images, such as a building. More specifically, the controller 5 is configured to determine latitude and longitude coordinates of the portable electronic device 100 according to the GPS signal outputted from the GPS unit 4, and to use the latitude and longitude coordinates to find the at least one candidate entry of object-of-interest data.

It is noted that step S13 of recognizing the object-of-interest in said one of the reality images is not limited to the techniques disclosed herein. The controller 5 may also recognize directly, without utilizing the GPS signal and without determining the latitude and longitude coordinates of the portable electronic device 100, the object-of-interest according to the series of reality images captured by the image capturing unit 2.

In step S14, the controller 5 is configured to generate at least one icon associated with the entry of object-of-interest data in the memory 3 that is associated with the object-of-interest thus recognized. The at least one icon is generated for enabling the user to perform operations associated with the icon through hand gesture. In the first preferred embodiment, the at least one icon represents one of a corresponding function, for example, “Home Page” or “Back to Previous Page”, an application program associated with the entry of object-of-interest data, for example, “Video Playback”, and any type of data associated with the entry of object-of-interest data, such as a file directory or a file, for example, “Taipei 101”, “Map”, “Suggested itinerary”, etc.

In step S15, the controller 5 is configured to generate a series of augmented reality images P₁ by overlaying the at least one icon onto the series of reality images captured by the image capturing unit 2.

In step S16, the display unit 1 is configured to display the augmented reality images P.

In step S17, the controller 5 is configured to recognize a relationship between the portion of the hand and the at least one icon in the series of augmented reality images P₁. In the first preferred embodiment, the controller 5 is configured to recognize a gesture of the portion of the hand in the series of augmented reality images P₁, and to generate gesture information which represents an action of the portion of the hand performed to the icon.

In step S18, the controller 5 is configured to generate an input instruction with reference to the relationship recognized in step S17. In the first preferred embodiment, the controller 5 is configured to generate the input instruction with reference to the gesture thus recognized. Specifically, the input instruction is generated with reference to the gesture information.

It is noted the present invention is not limited to recognizing the gesture, and may be implemented in a further fashion, such as, instep S17, recognizing, by the controller 5, a position of the portion of the hand relative to the at least one icon in the series of augmented reality images P₁ and in step S18, generating, by the controller 5, the input instruction when the portion of the hand is adjacent to the icon. In this fashion, in step S17, the controller 5 recognizes the position of the portion of the hand relative to the at least one icon in the series of augmented reality images P₁ using plane coordinates of each of the portion of the hand and the at least one icon in the series of augmented reality images P₁. In step S18, the controller 5 generates the input instruction when a distance between the plane coordinates of each of the portion of the hand and the at least one icon is smaller than a predetermined threshold value.

In step S19, the controller 5 is configured to execute the input instruction generated in step S18.

FIGS. 3 to 6 are examples for illustrating concrete processing procedures of step S14 to step S19.

Referring to FIG. 3, the controller 5 (see FIG. 1) in step S14 generates an icon I₁ which represents “Home Page”, and subsequently generates (step S15) and displays (step S16) the series of augmented reality images P₁. When the user performs an action for selecting the icon I_{I} through a gesture of the portion of the hand, the controller 5 in step 17 recognizes the gesture of the portion of the hand in the series of augmented reality images P₁ as a pointing gesture in which a finger of the portion of the hand is kept straight so as to generate the gesture information which represents “pointing”, and recognizes plane coordinates of each of a tip of the finger of the portion of the hand and the icon I₁ in the series of the augmented reality images P₁. When the controller 5 recognizes that the tip of the finger of the portion of the hand is adjacent to the icon I₁, the controller 5 in step S18 generates the input instruction which is associated with an operation of the icon I₁ according to the gesture information (i.e., pointing) and the icon I₁ corresponding to the tip of the finger of the portion of the hand. In the first preferred embodiment, the input instruction is to open the “Home Page”.

However, the processing procedures of the steps according to the present invention are not limited to the abovementioned description. The input instruction generated according to the gesture information and the icon corresponding to the portion of the hand may be different when the corresponding icon represents a different function. Moreover, the steps of the present invention may be simplified without recognizing the gesture of the portion of the hand. For example, when the controller 5 recognizes that the portion of the hand is adjacent to the icon I₁, the input instruction is generated directly by the controller 5.

After the controller 5 performs step S19, that is executing the input instruction to open the “Home Page”, the controller 5 generates the icons I₂-I₄ shown in

FIG. 4, each of which represents “Landmark introduction”, “Suggested itinerary” and “Map”. When the user once again performs an action for selecting one of the icons I₂ by a gesture of the portion of the hand, the controller 5 recognizes the gesture of the portion of the hand (step S17), generates the input instruction (step S18), and executes the input instruction (step S19), and then the flow goes back to step S14. At this time, the controller 5 generates the icons I₅ and I₆ which are shown in FIG. 5 and each of which is associated with the entry of object-of-interest data in the memory 3 that is associated with the object-of-interest thus recognized in step S13. For example, each of the icons I₅ and I₆ represents a respective one of “Taipei 101” and “Ferris Wheel”. Moreover, each of the icons I₅ and I₆ is overlaid onto the series of reality images with reference to latitude and longitude coordinates contained in the entry of object-of-interest data associated with a respective one of the icons I₅ and I₆. Specifically, each of the icons I₅ and I₆ is overlaid onto a position of the series of reality images that corresponds to a respective one of the latitude and longitude coordinates. When the user selects one of the icons I₅, the controller 5 recognizes a gesture of the portion of the hand (step S17), generates the input instruction (step S18), and executes the input instruction (step S19) , and then the flow goes back to step S14. At this time, the controller 5 generates an icon, such as content of text shown in FIG. 6 which is a page of landmark introduction to Taipei 101. The aforementioned icons I₁ to I₆ and the content of text are all overlaid upon the series of reality images.

In step S13 of the first preferred embodiment, since the latitude and longitude coordinates of the portable electronic device 100 have been determined according to the GPS signal, and since the entry of object-of-interest data in the memory 3 that is associated with the object-of-interest thus recognized is also obtained by the controller 5, the portable electronic device 100 is capable of providing a navigation function, in which the portable electronic device 100 utilizes a navigation unit (not shown) to provide navigation information associated with the object-of-interest. The portable electronic device 100 may store a software program, an icon and a listing corresponding to the software program for enabling the portable electronic device 100 to provide the navigation function.

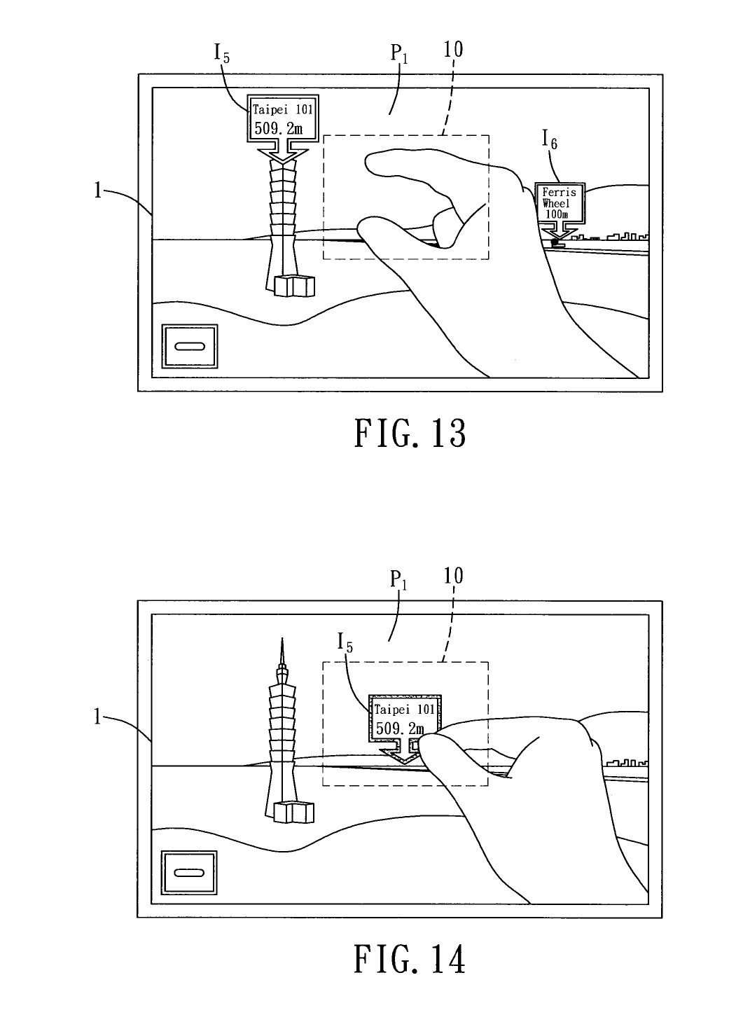

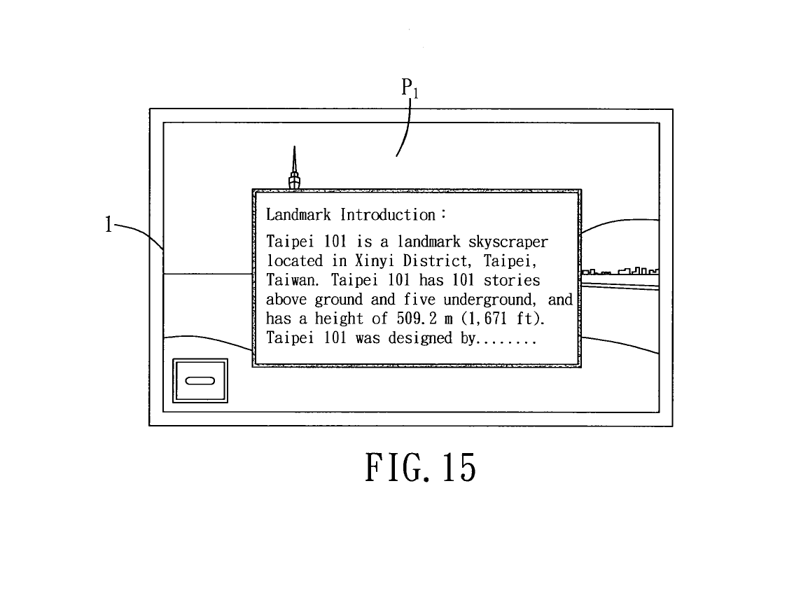

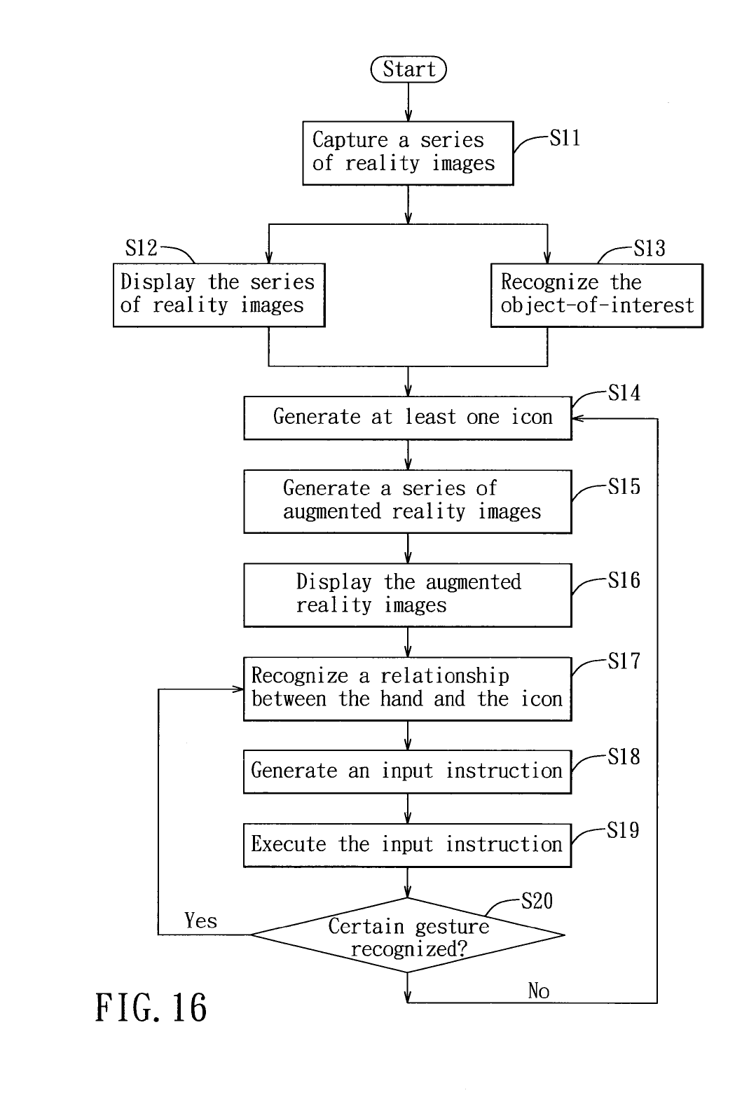

Referring to FIG. 1, FIG. 2, FIG. 9 and FIG. 16, a second preferred embodiment of the method for generating an instruction in an augmented reality environment according to the present invention is illustrated. The second preferred embodiment differs from the first preferred embodiment in that the display unit 1 further displays an execution zone 10 on a display screen of the display unit 1 in step S16, and that steps S17 and S18 are repeated when certain gestures of the portion of the hand are recognized (step S20).

In the second preferred embodiment, the method for generating the instruction in the augmented reality environment is further programmed with many kinds of conditions for recognizing the gesture of the portion of the hand. Alternatively, the memory 3 may store a listing associated with the conditions for recognizing the gesture of the portion of the hand.

In step S17, when the controller 5 recognizes that the gesture corresponds to a pointing gesture in which a finger of the portion of the hand is kept straight as shown in FIG. 7, i.e., the gesture information represents “pointing”, and that a tip of the finger of the portion of the hand is adjacent to the icon I₁, the input instruction generated by the controller in step S18 is associated with an operation of selecting the icon I₁. Subsequently, the controller 5 executes the input instruction associated with the operation of selecting the icon I₁, determines in step S20 that a certain gesture (i.e., the pointing gesture) is recognized, and repeats step S17 and S18.

In step S17, when the controller 5 recognizes that the gesture corresponds to a pinching gesture in which a number of fingers of the portion of the hand cooperate to form an enclosed shape adjacent to the icon as illustrated in FIG. 8, i.e., the gesture information represents “pinching”, and that the portion of the hand is simultaneously displaced in the series of augmented reality images P₁, the input instruction generated by the controller 5 in step S18 is associated with an operation of dragging the icon in the series of augmented reality images P₁ along a path corresponding to the displacement of the portion of the hand. Subsequently, the controller 5 executes the input instruction associated with the operation of dragging the icon along the path corresponding to the displacement of the portion of the hand, determines in step S20 that a certain gesture (i.e., the pinching gesture) is recognized, and repeats steps S17 and S18.

Referring to FIG. 9, the user drags the icon I₁ to the execution zone 10. In step 17, when the controller recognizes that the icon has been dragged to the execution zone 10, and that the gesture corresponds to a releasing gesture in which the fingers of the portion of the hand cooperate to form an open arc shape, i.e., the gesture information represents “releasing”, the input instruction generated by the controller 5 in step S18 is associated with an operation of terminating dragging of the icon. At the same time, an input instruction associated with at least one of: launching an application program corresponding to the icon I₁; opening a file directory corresponding to the icon I₁; and opening a file corresponding to the icon I₁ is automatically generated by the controller 5 in step S18. After the controller 5 executes the input instruction in step S19, the flow goes back to step S14, and the series of augmented reality images P₁ is illustrated in FIG. 11.

When the user performs once again the aforementioned operations in a manner of performing the pinching gesture following the pointing gesture to drag the icon I₂ from a position illustrated in FIG. 11 to another position illustrated in FIG. 12, i.e., within the execution zone 10, and subsequently performing the releasing gesture as illustrated in FIG. 13, the controller 5 recognizes the gestures and generates an input instruction which is associated with opening a file directory corresponding to the icon I₂. Afterward, the controller 5 generates icons I₅ and I₆, generates a series of augmented reality images P₁ by overlaying the icons I₅ and I₆ onto the series of reality images, and displays the series of augmented reality images P₁ as illustrated in FIG. 13. Each of the icons I₅ and I₆ is overlaid onto a position of the series of reality images that corresponds to the latitude and longitude coordinates contained in the entry of object-of-interest data associated with a respective one of the icons I₅ and I₆. In the example, each of the icons I₅ and I₆ represents a respective one of “Taipei 101” and “Ferris Wheel”.

When the user performs once again the aforementioned operations in a manner of performing the pinching gesture following the pointing gesture to drag the icon I₅ from the position illustrated in FIG. 13 to another position illustrated in FIG. 14, i.e., within the execution zone 10, and subsequently performing the releasing gesture, the controller 5 recognizes the gestures and generates an input instruction which is associated with opening a file corresponding to the icon I₅. After the controller 5 executes the input instruction in step S19, a series of augmented reality images P₁ is generated and displayed as illustrated in FIG. 15.

It is noted that repetition of steps S17 and S18 in the second preferred embodiment may also be simplified in a manner that the controller 5 recognizes a position of each of the portion of the hand and the icon in the series of augmented reality images P₁, and recognizes a position of the execution zone 10 displayed on the display screen of the display unit 1. When the controller 5 in step S17 recognizes that a distance between the positions of the portion of the hand and the icon is smaller than a predetermined threshold value, an input instruction generated by the controller 5 in step S18 is associated with operations of selecting and dragging the icon. When the controller 5 further recognizes in step S17 that the icon has been dragged to the execution zone 10, the input instruction generated by the controller 5 in step S18 is associated with at least one of: launching an application program corresponding to the icon; opening a file directory corresponding to the icon; and opening a file corresponding to the icon.

To sum up, the method for generating an instruction in an augmented reality environment according to the present invention enables the user to perform virtual operations upon the icon in the series of augmented reality images P₁ by extending the portion of the hand into the field of view of the image capturing unit 2 of the portable electronic device 100, such that the portable electronic device 100 is able to generate a corresponding input instruction without input via a touch screen or physical buttons.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for generating an instruction in an augmented reality environment, the method to be performed using an electronic device which includes a display unit, an image capturing unit, a memory that stores a plurality of entries of object-of-interest data, and a controller coupled electrically to the display unit, the image capturing unit and the memory, the method comprising the steps of:
(A) capturing, by the image capturing unit, a series of reality images, each of which contains at least a portion of a hand and further contains a scene that includes at least one object-of-interest and that serves as a background of the portion of the hand;
(B) recognizing, by the controller, the object-of-interest in one of the reality images captured by the image capturing unit;
(C) generating, by the controller, at least one icon associated with the entry of object-of-interest data in the memory that is associated with the object-of-interest thus recognized;
(D) generating, by the controller, a series of augmented reality images by overlaying the at least one icon onto the series of reality images captured by the image capturing unit;
(E) displaying, by the display unit, the augmented reality images;
(F) recognizing, by the controller, a relationship between the portion of the hand and the at least one icon in the series of augmented reality images; and
(G) generating, by the controller, an input instruction with reference to the relationship recognized in step (F).

2. The method of claim 1, wherein the object-of-interest recognized in step (B) is a landmark in the scene.

3. The method of claim 2, the electronic device further including a positioning unit coupled to the controller and configured to output a current position of the electronic device, wherein step (B) includes:
finding, by the controller, from the entries of object-of-interest data in the memory at least one candidate entry of object-of-interest data corresponding to a candidate object-of-interest located within an area that contains the current position of the electronic device and that is associated with a field of view of the image capturing unit; and
finding, by the controller, the candidate object-of-interest in said one of the reality images captured by the image capturing unit;
wherein the candidate object-of-interest found by the controller in said one of the reality images is recognized by the controller as the object-of-interest in said one of the reality images.

4. The method of claim 3, wherein the positioning unit is a global positioning system (GPS) unit which is configured to receive and output a GPS signal that contains the current position of the electronic device, and step (B) includes:
determining, by the controller, latitude and longitude coordinates of the electronic device according to the GPS signal, and
using, by the controller, the latitude and longitude coordinates to find the at least one candidate entry of object-of-interest data.

5. The method of claim 1, wherein:
step (F) includes: recognizing, by the controller, a position of the portion of the hand relative to the at least one icon in the series of augmented reality images; and
step (G) includes: generating, by the controller, the input instruction when the portion of the hand is adjacent to the icon.

6. The method of claim 5, wherein, in step (F), the controller recognizes the position of the portion of the hand relative to the at least one icon in the series of augmented reality images using plane coordinates of each of the portion of the hand and the at least one icon in the series of augmented reality images.

7. The method of claim 1, wherein:
step (F) includes: recognizing, by the controller, a gesture of the portion of the hand in the series of augmented reality images; and
step (G) includes: generating, by the controller, the input instruction with reference to the gesture thus recognized.

8. The method of claim 7, wherein:
step (F) further includes: recognizing, by the controller, a position of the portion of the hand relative to the at least one icon in the series of augmented reality images; and
step (G) includes: generating, by the controller, the input instruction when the portion of the hand is adjacent to the icon.

9. The method of claim 8, wherein, when the controller recognizes in step (F) that the gesture corresponds to a pointing gesture in which a finger of the portion of the hand is kept straight and that a tip of the finger of the portion of the hand is adjacent to the icon, the input instruction generated by the controller in step (G) is associated with an operation of selecting the icon.

10. The method of claim 9, further comprising:
(H) executing, by the controller, the input instruction generated in step (G); and
(I) repeating steps (F) and (G);
wherein when the controller recognizes in step (I) that the gesture corresponds to a pinching gesture in which a number of fingers of the portion of the hand cooperate to form an enclosed shape adjacent to the icon, and that the portion of the hand is simultaneously displaced in the series of augmented reality images, the input instruction generated by the controller in step (I) is associated with an operation of dragging the icon in the series of augmented reality images along a path corresponding to the displacement of the portion of the hand.

11. The method of claim 10, further comprising:
(J) executing, by the controller, the input instruction generated in step (I); and
(K) repeating steps (F) and (G);
wherein when the controller recognizes in step (K) that the gesture corresponds to a releasing gesture in which the fingers of the portion of the hand cooperate to form an open arc shape, the input instruction generated by the controller in step (K) is associated with an operation of terminating dragging of the icon.

12. The method of claim 11, wherein, in step (E), the display unit further displays an execution zone on a display screen of the display unit, and
wherein when the controller further recognizes in step (K) that the icon has been dragged to the execution zone, the input instruction generated by the controller instep (K) is further associated with at least one of:
launching an application program corresponding to the icon; opening a file directory corresponding to the icon; and opening a file corresponding to the icon.

13. The method of claim 1, wherein, in step (D), the at least one icon is overlaid onto the series of reality images with reference to latitude and longitude coordinates contained in the entry of object-of-interest data associated therewith.

14. An electronic device comprising:
a display unit;
an image capturing unit for capturing a series of reality images, each of which contains at least a portion of a hand and further contains a scene that includes at least one object-of-interest and that serves as a background of the portion of the hand;
a memory that stores a plurality of entries of object-of-interest data; and
a controller coupled electrically to the display unit, the image capturing unit and the memory;
wherein the controller is configured to: recognize the object-of-interest in one of the reality images captured by the image capturing unit; generate at least one icon associated with the entry of object-of-interest data in the memory that is associated with the object-of-interest thus recognized; and generate a series of augmented reality images by overlaying the at least one icon onto the series of reality images captured by the image capturing unit;
wherein the display unit is configured to display the augmented reality images; and
wherein the controller is further configured to: recognize a relationship between the portion of the hand and the at least one icon in the series of augmented reality images; and generate an input instruction with reference to the relationship recognized thereby.

15. A method for generating an instruction in an augmented reality environment, the method to be performed using an electronic device which stores a plurality of entries of object-of-interest data, the method comprising the steps of:
(a) capturing, by the electronic device, a series of reality images, each of which contains at least a portion of a hand and further contains a scene that includes at least one object-of-interest and that serves as a background of the portion of the hand;
(b) recognizing, by the electronic device, the object-of-interest in one of the reality images;
(c) generating, by the electronic device, at least one icon associated with the entry of object-of-interest data that is associated with the object-of-interest thus recognized;
(d) generating, by the electronic device, a series of augmented reality images by overlaying the at least one icon onto the series of reality images;
(e) displaying, by the electronic device, the augmented reality images;
(f) recognizing, by the electronic device, a relationship between the portion of the hand and the at least one icon in the series of augmented reality images; and
(g) generating, by the electronic device, an input instruction with reference to the relationship recognized in step (f).
